(19) United States
(12) Patent Application Publication
(10) Pub. No.: US 2026/0103304 A1
(43) Pub. Date: Apr. 16, 2026

(54) MULTISOURCE POWER CONTROL AND MANAGEMENT FOR ELECTRICALLY POWERED UNMANNED AIRCRAFT SYSTEMS

(71) Applicant: The United States of America, as Represented by the Secretary of the Navy, Crane, IN (US)

(72) Inventors: Corey Alexis Marvin Bergsrud, Bloomington, IN (US); Eric B. Scott, Heltonville, IN (US); Steven T. Holland, Crane, IN (US)

(73) Assignee: The United States of America, as represented by the Secretary of the Navy, Arlington, VA (US)

(21) Appl. No.: 18/915,765

(22) Filed: Oct. 15, 2024

Related U.S. Application Data
(60) Provisional application No. 63/543,767, filed on Oct. 12, 2023.

(51) Int. Cl. B64U 50/35; B64U 10/14

(52) U.S. Cl. CPC B64U 50/35; B64U 10/14

(57) ABSTRACT

A power management system for electrically powered unmanned aircraft systems (UASs) providing power control and power management in such UASs having multiple sources of power and tasked with various mission requirements. In an aspect, the power management system may include a processor or controller that receives current and voltage measurements of the UAS power systems and then controls loads based on the measurements, as well as manage received power from a power receiver (e.g., rectenna) and interface with on-board energy storage management systems to control charging and discharge of energy storage devices such as batteries and/or capacitors.

### CROSS-REFERENCE TO RELATED APPLICATIONS

This application claims priority to and the benefit of U.S. Provisional Patent Application Ser. No. 63/543,767, filed on Oct. 12, 2023, entitled “MULTISOURCE POWER CONTROL AND MANAGEMENT FOR ELECTRICALLY POWERED UNMANNED AIRCRAFT SYSTEMS,” the disclosure of which is expressly incorporated herein by reference.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 200480US02) is assigned to the United States Government and is available for licensing for commercial purposes. Licensing and technical inquiries may be directed to the Technology Transfer Office, Naval Surface Warfare Center Crane, email: Crane_T2@navy.mil.

### FIELD

The field of the present invention relates generally to power management for unmanned aircraft systems (UASs), and more particularly to power control and power management in electrically powered UASs having multiple sources of power and tasked with various mission requirements.

### BACKGROUND

Currently on-board power control and/or power management is minimal within most small drone systems or similar UASs during flight. Such UASs are typically recharged at a ground station (e.g., tethered or through inductive charging or with battery swapping) and flight times are limited to around 20-30 minutes. Some UASs include power scavenging, which is an emerging technology. Battery recharging systems are readily available but they are typically ground operations requiring some human control. Power management systems exist for batteries and power systems to track remaining charge and prevent unsafe conditions that could result in a battery fire or explosion.

Concerning wireless powering, it is noted that powering a small tethered electric helicopter with microwaves was accomplished by W. C. Brown in 1964. However, integrating and miniaturizing charge measurement, power control and recharging into a light weight energy dense system capable of being placed on an drone (e.g., either autonomous or human operated) to manage incoming power from various power sources such as microwave power sources, millimeter wave power sources, energy harvested from power lines, or any other noncontact transmissible power methods and routing the collected energy to motors and/or storage devices and/or electric payloads simultaneously is not known. Present systems typically do not have inflight recharging and the power management is performed by the operator through a wireless control.

Accordingly, there is a need to indefinitely sustain flight operations for a UAS (e.g., a drone, quadcopter, or other autonomous systems (robot)), which includes power management. To efficiently achieve this operational condition, an in-air energy refueling operation with interactive power management is desirable. In particular, a power manager is desirable to be able to receive incoming power, control conversion of the power (e.g., AC to DC or DC to DC), and intelligently/autonomously transfer the power to on-board storage or to UAS loads as needed, while reporting and/or tracking the energy usage to a supported system control module energy usage and reserves for on-the-fly mission planning.

### SUMMARY

The present disclosure relates to power management systems for drones or UASs that manage the flow of power used in drones to better manage power resources within the drones, particularly for fully autonomous operations. In more detail, the disclosed power management systems are on-board systems that are capable of receiving power while a drone is in flight, and then routing power to where it may be best used for each particular mission of the drone or even each particular mission task occurring during a mission.

In an aspect, a power management system for a drone or UAS is disclosed. The system includes at least one input configured to receive one or more inputs including at least one of control signals, information from an energy storage device management system, voltage measurements of loads or energy storage devices on-board the drone, and current measurements of loads or energy storage devices on-board the drone; at least one output for providing one or more control signals to at least one of a drone load, an energy storage source, a battery management system, a source of drone power, a power receiver, or a switching circuit for control of loads or energy sources; and at least one processor configured to determine or generate the one or more control signals based, in part, on the received one or more inputs.

### BRIEF DESCRIPTION OF THE DRAWINGS

The detailed description herein particularly refers to the accompanying figures in which:

FIG. 1 shows a high-level illustration of one example of an environment in which a UAS or drone is operable according to some aspects of the disclosure.

FIG. 2 illustrates an exemplary block diagram of a drone or UAS system according to some aspects of the disclosure.

FIG. 3 illustrates an exemplary block diagram of a power management system for a drone or UAS system according to some aspects of the disclosure.

FIG. 4 illustrates yet another example block diagram of a UAS or drone system that includes power management or control system according to some aspects of the disclosure.

FIG. 5 illustrates yet another example of a UAS or drone system including a power management board or unit according to some aspects of the disclosure.

FIG. 6 illustrates an exemplary circuit schematic diagram for at least portions of a power management unit according to some aspects of the disclosure.

### DETAILED DESCRIPTION

The embodiments or examples of the invention described herein are not intended to be exhaustive or to limit the invention to the precise forms disclosed. Rather, the embodiments or examples selected for description have been chosen to enable one skilled in the art to practice the invention.

Presently known approaches for management of drones or UAS systems preclude fully autonomous operations because of the continued need for user input in such systems, including input for management of power. Accordingly, the presently disclosed invention provides a power and control backbone for true autonomous flight for hours, days, weeks, and even years, if required.

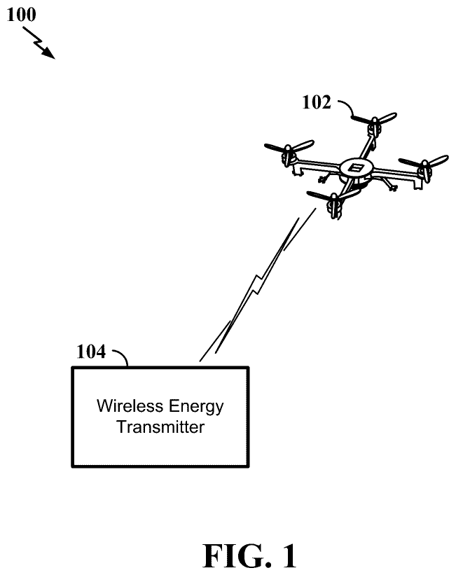

FIG. 1 provides a high-level illustration of one example of an environment 100 in which a UAS or drone 102 is operable. The present disclosure, while not limited to such, includes implementation in drones 102 that are capable of receiving power from an external energy source for sustained flight and operation. In this exemplary environment 100, a wireless energy transmitter 104, such as a microwave transmitter or a laser for optical power transmission, provides wireless energy transmission to the drone 102. As will be described in more detail below, drone 102 includes a power management system, power management unit (PMU), or “power manager” that serves to manage both power resources and system loads for optimization of the energy resource on-board the drone 102.

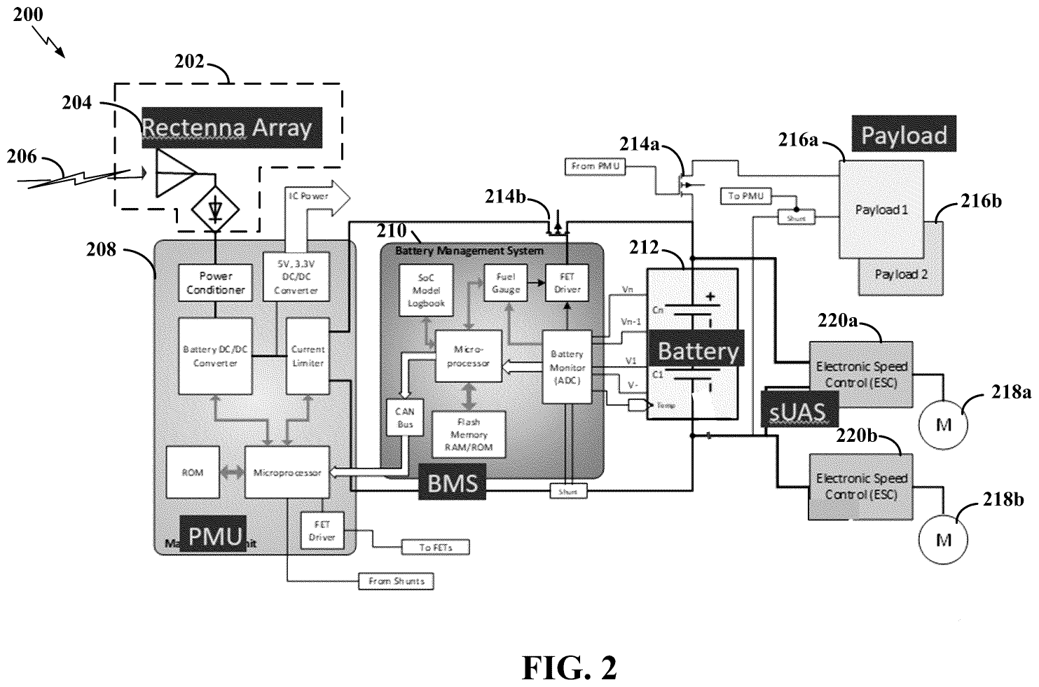

FIG. 2 illustrates an exemplary block diagram of a drone or UAS system 200, and, in particular, the systems on board a drone or UAS such drone 102 shown in FIG. 1. The illustrated system 200 includes a power receiver unit 202, which may include one or more rectennas (e.g., a rectenna array 204) as indicated in the figure. The power receiver unit 202 receives wireless power transmissions such as radio frequency (RF), microwave, millimeter wave, or even optical frequency electromagnetic transmissions 206 and converts the energy thereof to direct current (DC) through rectification (although this could be left as alternating current (AC) in other examples and implementations). In other aspects, the power receiver unit 202 may include a boost converter for the rectenna power inputs.

The power receiver unit 202 is coupled to a power management unit (PMU) 208. PMU 208 receives power (e.g., electrical current) from the power receiver unit 202. As merely exemplary and not limited to such, the illustrated PMU 208 may include one or more of a power conditioner, one or more DC to DC converters (e.g., DC to DC voltage converter for conversion of incoming voltage to a voltage used by the on-board batteries, a DC to DC voltage converter for integrated circuit (IC) loads (e.g., a 5V to 3.3 V converter)), at least one microprocessor or microcontroller (which may be further integrated with other hardware or processing devices on a same circuit board), a memory device (e.g., a RAM, ROM, EEPROM, etc.) coupled to the at least one microprocessor, a current limiter for limiting battery charging current, and a switching control circuit (e.g., a field effect transistor (FET) driver circuit) for controlling switches (e.g., FETs, MOSFETs, etc., but not limited to such semiconductor devices) for load allocation and battery charging control, as examples. Moreover, the PMU 208 may receive inputs from various “shunts” (i.e., shunt resistors, of which a couple examples are illustrated in FIG. 2) or other current measurement devices or means, as well as voltage measurement devices or means, the outputs of which may be input to the at least one microprocessor for processing and evaluation. Additionally, in one example the switching control circuit may receive inputs and control signaling from the at least one microprocessor to control loads and or battery charging based on calculations and determinations made by the at least one microprocessor. The FET driver, in one aspect, may control one or more various switches such as FET 214a, as merely one example, for controlling payloads 216a or 216b.

In further aspects, the PMU 208 may be configured such that the device may accommodate additional current carrying capacity to meet fast charge battery targets (e.g., 15 A and 22 A charging). Moreover, a printed circuit board (PCB) layout for the PMU 208 may include various features for thermal management including thermal vias in the PCB, and increased area of copper used for heat dissipation.

In yet further aspects, the PMU 208 may include one or more ports that are configured for receiving power while the drone or UAS is in flight and then for routing that power where it can best be used. Each power connection (incoming or storage) is optional and may be configured to the most appropriate UAS configuration for a particular mission. For example, in one configuration the drone or UAS may be configured with a rectenna, a lithium battery, and a super capacitor. In another configuration, the drone or UAS could be configured with two (or more) lithium batteries and no power receiving hardware. In yet another configuration, the drone or UAS may be flown using only power receiving hardware (i.e., rectenna) and no power storage. For all configurations, the PMU 208 is configured to automatically recognize each particular UAS configuration and manage the power resources according to predetermined algorithms. In other aspects, it is noted that the PMU 208 may employ artificial intelligence/machine learning (AI/ML) to recognize and analyze the configured loads and power sources, as well as other factors such as battery charging characteristics for optimal load switching and battery charging. Power sources, storage and loads could all be preconfigured in the PMU 208 prior to operation or, alternatively, each of the power sources and/or loads may self-identify to the PMU 208 when plugged in, and the PMU 208 responds according to the algorithms or AI/ML for power management.

The drone or UAS system 200 may also include a battery management system (BMS) 210, which is configured to control the charging and maintenance/monitoring of one or more energy storage devices such as batteries or battery cells 212 on board the drone system 200. The BMS 210 may include at least one microprocessor, a memory device (e.g., a flash memory RAM, ROM, EEPROM, etc.) coupled to the at least one microprocessor and a battery monitor such as an analog to digital convertor (ADC), which receives one or more voltage inputs from the one or more cells in the battery 212, as well as temperature measurements and current measurements from a shunt resistor (or similar current measurement device) or voltage measurements. The BMS 210 may also include a system on a chip (SoC) model logbook, a fuel gauge, and a communication bus that interfaces communicatively with the at least one microprocessor in PMU 208. Furthermore, the BMS 210 may include a switching controller (e.g., a FET driver) that may selectively operate a switching device (e.g., a FET 214b) on and off for controlling charging and other regulation of the battery 212.

The system 200 also includes one or more payloads 216, which may include devices such as imaging devices such as cameras (FLIR camera, LWIR camera, SWIR camera, IR camera, optical spectrum camera, etc.), audio/visual devices (e.g., speakers, projectors, lasers), RF devices, weapons systems, etc. In an aspect, the system 200 may include switching devices (e.g., FET 214a) under the control of the PMU 208 that allows the PMU 208 to control at least power delivery to the payloads 216. In other aspects, the PMU 208 may be configured to control energy usage within a particular payload rather than switch the load on/off (e.g., switch between high/low power modes of the payload).

Additionally, the system 200 includes the drive or propulsion motors 218 and controllers (e.g., electronic speed controllers (ESC) 220) for the motors. While not illustrated in FIG. 2, in some aspects the PMU 208 may receive measurement inputs concerning voltage and/or current measurements concerning the loads of the motors 218 and/or the controllers 220. Furthermore, the PMU 208 may include outputs (not shown) that provide feedback and/or power management instructions to the speed controllers 220 and/or motors 218.

As will be appreciated by those skilled in the art, the present PMU 208 design affords the ability to charge one or multiple batteries. Additionally, the PMU 208 may automatically (i.e., intelligently) turn on/off drone payloads, the batteries, and the BMS based on circuitry measurements and fault signals. Furthermore, the PMU 208 allows for the option of having the rectenna power only the charging of the batteries, only powering the payload(s), only powering the motors, or any combination of these loads. Still further, the PMU 208 may be configured to enable a variety of payload at various voltages (e.g., up to 24 Volts, but not limited to such), and may include a software defined radio (SDR) with an amplifier.

In yet further aspects, the PMU 208 may receive temperature inputs from one or more temperature sensors (not shown) in the UAS or drone. The temperature inputs may, in turn, be used to manage thermal conditions on the drone such as by reducing loads or controlling battery charging.

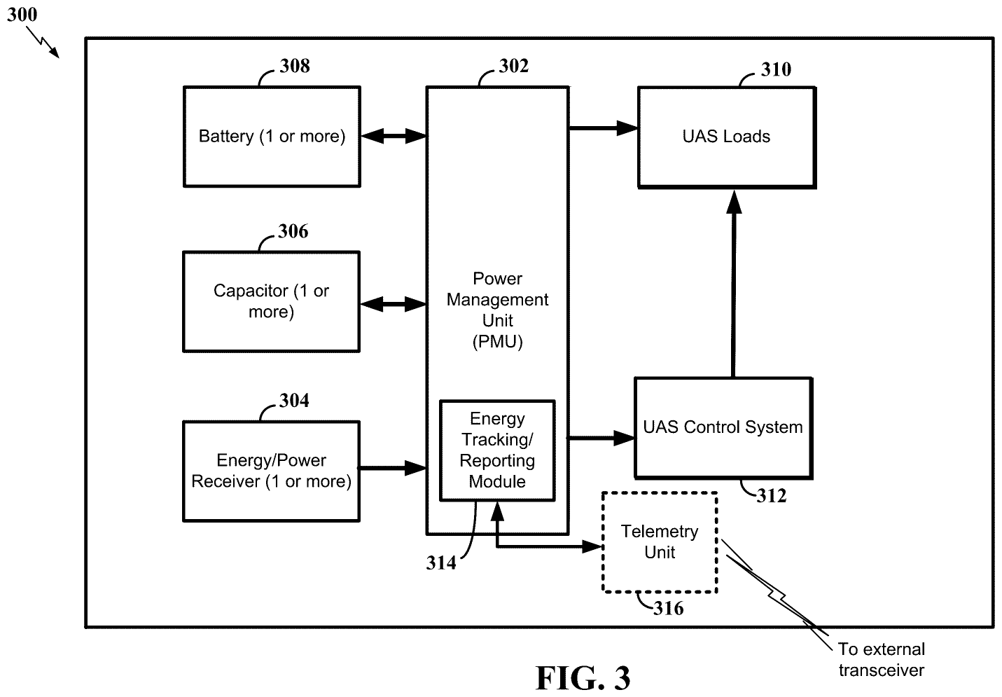

FIG. 3 illustrates another exemplary block diagram of a power management system 300 for a drone or UAS according to aspects of the present disclosure. As illustrated, the power management system 300 includes a power management unit (PMU) 302 configured to implement power management functions including, but not limited to, receiving power from a power receiver 304 (e.g., a rectenna), power conversion of the power received from the power receiver 304, management of energy storage to a capacitor 306 and/or a battery 308 (or battery management system such as BMS 210 shown in FIG. 2), control of UAS loads 310, and/or output to a UAS control system 312.

In further aspects, the PMU 302 may include an energy tracking/reporting module 314 that logs or tracks energy usage within the drone or UAS and store such information for reporting to a user. In yet further aspects, the module 314 may be implemented with hardware, software, or combinations thereof, and may alternatively be implemented by a processor that effects operations of the PMU 302 at large. In yet other aspects, the module 314 may be coupled to an optional telemetry unit 316 (e.g., an RF unit or SDR) that is configured to transmit the energy usage to an external transceiver, as well as receive input information from the transceiver based on the reported information.

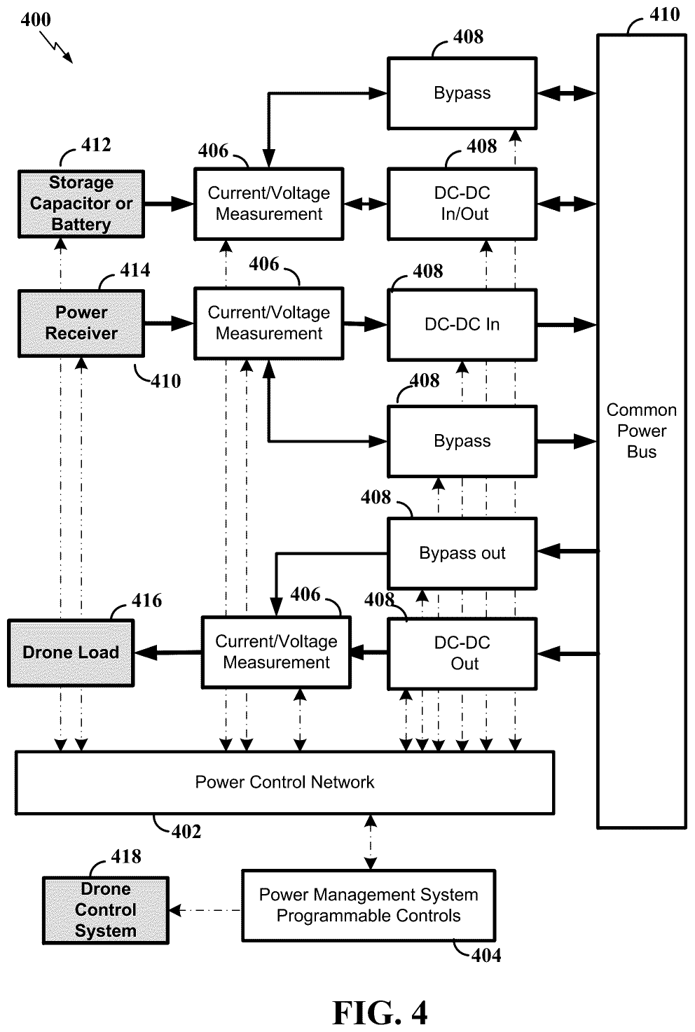

FIG. 4 illustrates yet another example block diagram of a UAS or drone system 400 that includes power management or control system (e.g., a power control network 402, a power management system/programmable controller 404, current/voltage measurement devices 406, and various input, DC-DC blocks, and bypass devices 408, and a common power bus 410). The shaded boxes of capacitor/battery storage 412, power receiver 414, drone load 416, and drone control system 418, indicate hardware external to the power control system. Dashed lines indicate control signals to report information or configure power flow. Bypass is used if the source or load is at the common bus voltage to improve efficiency by eliminating the DC-DC path. The DC-DC blocks are power supplies that convert the power form/to the power bus into what is needed or supplied by the load or source. When a battery or capacitor is connected, the power management system also provides safe charge control. Other control lines from 402/404 to devices (e.g., 412, 414) represent configuration data for the storage systems and the power receiving hardware. Such configuration data may include operational voltage, current, impedance, storage capacity, charge profile, safe limits, etc. This ensures that the power management system is forward compatible for future developments.

In some examples, the power control network 402 can be configured using an I2C bus (or other existing network technology) or direct control and measurement lines tied to commercial ADC/DAC IC's. The programmable controls (e.g., 404) may be embodied as embedded software that coordinates power and data from the storage and input lines, through the common bus and to the loads. The controls 404 may be configured with the information provided by the receiver element attached and the battery (Bat) or Capacitor (Cap) that is attached, as well as to report capacity and load information to the Drone Control System 418 for mission planning.

An advantage of the disclosed Power Management System is that it allows for a configurable power system that provides in-flight refueling of drones, support for all chemistry safe battery charging/discharging and super-cap/ultra-cap/lithium-cap (all current and future) high energy capacitors support in a single power control system with plug and play capability. The Power Management System approach is also applicable in any autonomous, semi-autonomous or human operator controlled electric system that requires charge management and recharging capacity with built in support for current and new charging and storage technologies.

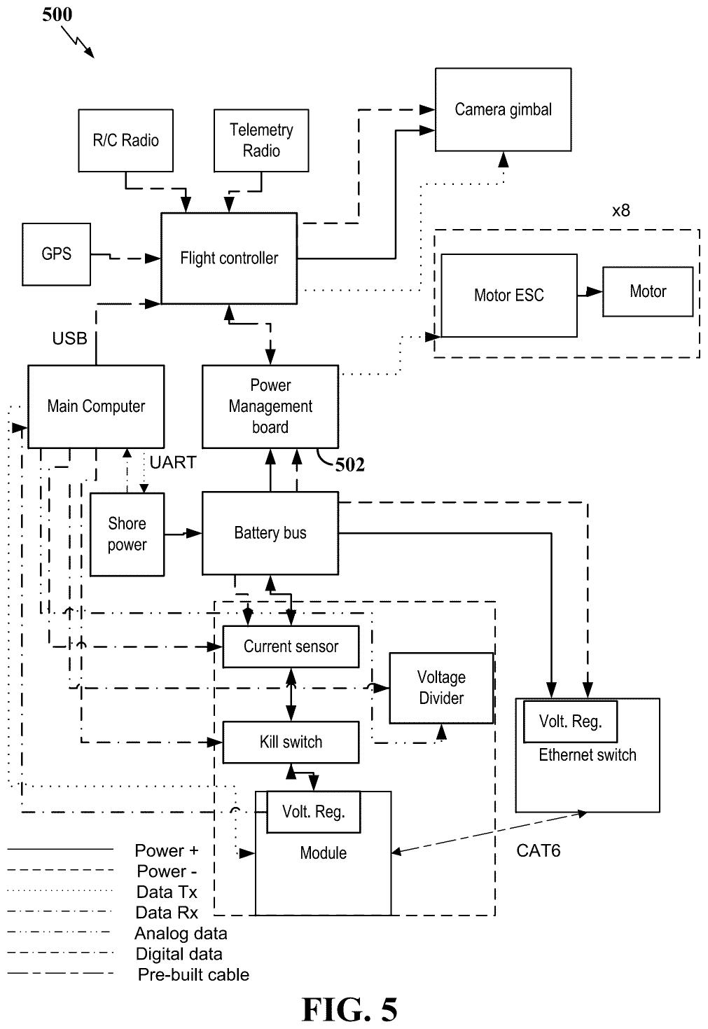

FIG. 5 illustrates yet another example of a UAS or drone system 500 including a power management board or unit 502. As shown, the unit 502 may control power, as well as control data flows to various systems on the UAS. In aspects, the unit 502 may accommodate usage and charging of two or more batteries. Furthermore, the unit 502 may be configured to provide intelligent switching, turning payloads on/off, battery charging and connections, a battery management based on circuit measurements and fault signals. Moreover, the unit 502 may include data recording of voltage/current readings, allow for the option of: (1) having the input power only charge the batteries, (2) only power the payload, (3) only power the motors, or (4) any combination of (1)-(3).

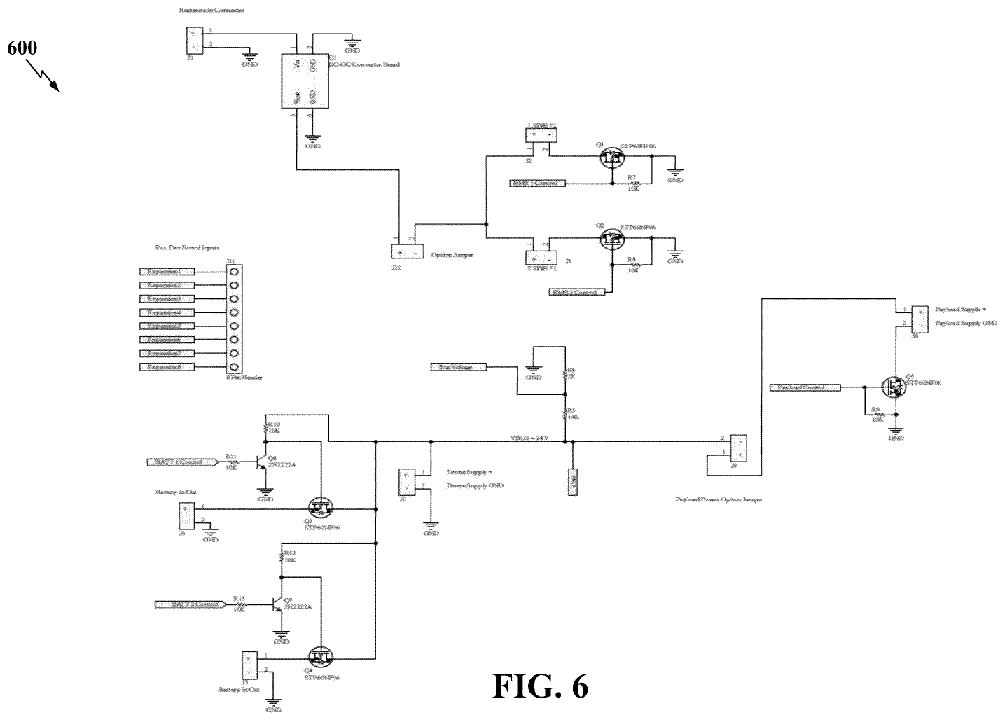

FIG. 6 illustrates an exemplary circuit schematic diagram 600 for at least portions of a power management unit according to some aspects of the disclosure. This circuitry 600 is one example of circuitry incorporated in units 302 or 502, as examples.

Although the present invention has been described in detail with reference to certain examples or embodiments, variations and modifications exist within the spirit and scope of the present invention as described and as defined in the following claims.

1. A power management system for a drone comprising:
at least one input configured to receive one or more inputs including at least one of control signals, information from an energy storage device management system, voltage measurements of loads or energy storage devices on-board the drone, current measurements of loads or energy storage devices on-board the drone, and temperature measurements;
at least one output for providing one or more control signals to at least one of a drone load, an energy storage source, a battery management system, a source of drone power, a power receiver, or a switching circuit for control of loads or energy sources; and
at least one processor configured to determine or generate the one or more control signals based, in part, on the received one or more inputs.

2. The power management system of claim 1, further comprising:
at least one memory device coupled to that at least one processor for storing information about conditions and controls effectuated in the drone, and/or code for executing power management functions.

3. The power management system of claim 1, further comprising:
wherein the at least one processor is configured to provide a configurable power system including one or more of:
in-flight refueling of the drone; support for a plurality of safe battery charging/discharging and super-cap/ultra-cap/lithium-cap (all current and future) high energy capacitors support in a single power control system; and/or provide a plug and play capability configured to enable support for presently known and new charging and storage technologies.

4. The power management system of claim 1, wherein the power management system is configured for autonomous, semi-autonomous, or human operator controlled operations.

5. An unmanned aerial system (UAS) comprising:
at least one power management system comprising:
at least one input configured to receive one or more inputs including at least one of control signals, information from an energy storage device management system, voltage measurements of loads or energy storage devices on-board the UAS, current measurements of loads or energy storage devices on-board the UAS, and temperature measurements;
at least one output for providing one or more control signals to at least one of a UAS load, an energy storage source, a battery management system, a source of UAS power, a power receiver, or a switching circuit for control of loads or energy sources; and
at least one processor configured to determine or generate the one or more control signals based, in part, on the received one or more inputs.

6. The UAS of claim 5, further comprising:
at least one memory device coupled to that at least one processor for storing information about conditions and controls effectuated in the UAS, and/or code for executing power management functions.

7. The UAS of claim 5, further comprising:
wherein the at least one processor is configured to provide a configurable power system including one or more of in-flight refueling of the UAS; support for a plurality of safe battery charging/discharging and super-cap/ultra-cap/lithium-cap (all current and future) high energy capacitors support in a single power control system; and/or provide a plug and play capability configured to enable support for presently known and new charging and storage technologies.

8. The UAS of claim 5, wherein the power management system is configured for autonomous, semi-autonomous, or human operator controlled operations.
